(19) United States
(12) Patent Application Publication
(10) Pub. No.: US 2024/0289711 A1
(43) Pub. Date: Aug. 29, 2024

(54) METHOD FOR HIERARCHICALLY OPTIMIZING SCHEDULING PLAN OF HETEROGENEOUS HELICOPTER FLEET

(71) Applicant: BEIHANG UNIVERSITY, Beijing (CN)

(72) Inventors: Hu LIU, Beijing (CN); Yixiong YU, Beijing (CN); Yongliang TIAN, Beijing (CN)

(21) Appl. No.: 18/224,642

(22) Filed: Jul. 21, 2023

(30) Foreign Application Priority Data
Jul. 26, 2022 (CN) 202210884619.8

(51) Int. Cl. G06Q 10/0631; G06Q 50/26

(52) U.S. Cl. CPC G06Q 10/06312; G06Q 50/265

(57) ABSTRACT

A method for hierarchically optimizing a scheduling plan of a heterogeneous helicopter fleet, comprising: step 1: summarizing important information in a disaster situation, and constructing a structured input mission scenario; step 2: constructing a scheduling problem model of the heterogeneous helicopter fleet, wherein the model is decomposed into two hierarchies including a route planning problem model and a mission assignment optimization model; step 3: designing the solution data structures, using the mission assignment matrix as the corresponding data structure for the mission assignment optimization model, and using the helicopter mission route as the corresponding data structure for the route planning problem model; step 4: combining the solution data structures and the route planning problem model, and developing a route planning solver; step 5: combining the solution data structures, the mission assignment optimization problem model and the route planning solver, developing a solver for the optimization of the mission assignment matrix.

### TECHNICAL FIELD

This invention generally relates to the technical field of aerial emergency rescue and operational research (optimization of scheduling plan and route planning), and more particularly, to a method for hierarchically optimizing a macro scheduling plan of a heterogeneous helicopter fleet.

### BACKGROUND

Natural disasters often bring huge economic losses. In disasters, transportation infrastructures are easily damaged, resulting in high difficulty and complexity of post-disaster rescue. Aerial emergency rescue serves as an important force in natural disaster rescue. Helicopters are extensively used in natural disaster rescue due to their advantages such as hovering, high flexibility and ease of deployment when executing missions including material transportation, transfer of wounded persons, lifting, reconnaissance and firefighting. When a disaster occurs, the emergency management needs to organize emergency forces to perform rescue within the jurisdiction. For a navigation station, how to quickly make mission scheduling plans according to the rescue demand and resource information in combination with the capabilities of a helicopter fleet such that the flight plans for the helicopter fleet are smoothly filed is the most important thing, which is also an application issue related to the optimization technology of operational research.

Optimization of scheduling plans is a branch of the optimization of operational research, wherein the “scheduling of parallel machine” is a kind of problem that factories often face in their real manufacturing: a process is divided into a plurality of steps to complete. It allows the steps to be performed by any one machine in a group of machines. The purpose of scheduling is to assign steps to each machine and sort the steps performed by each machine to minimize the time spent for completing all steps. Focusing on the optimization of scheduling plans for helicopter fleets, Ozdamar L has conducted research on the helicopter post-disaster logistics coordination system and proposed an interactive method for hierarchical analysis of helicopter post-disaster logistics transportation. This method is capable of generating the most suitable flight route and the best configuration of an aircrew/fleet while solving the problems relating to the personnel allocation, route and transportation encountered in the initial response phase of the disaster rescue. However, the six levels proposed by this method are extremely complex, resulting in high difficulty of calculation. Meanwhile, Ozdamar L does not design a corresponding solver, and therefore, this method still stays in a theoretical stage and is lack of a fast and efficient optimization algorithm. As a result, it is difficult for common commercial software to complete the calculation within a reasonable duration.

When the mission to be executed is determined, and the location to be visited by the helicopter is known, how to make a scheduling plan is simplified to how to design a mission route of the helicopter, which essentially belongs to a vehicle route problem. In this field, based on a simulated firefighting and a local search meta-heuristic algorithm, OzKan proposed an algorithm for detecting the forest fire by using a plurality of bases and unmanned aerial vehicles (UAVs). This method is an application of a vehicle route problem in the field of aerial emergency rescue. However, it is merely applicable for situations where UAVs are used for search, failing to process more complex problems relating to material transportation and personnel transfer.

In conclusion, the prior art mainly has the following defects: first, although making a macro scheduling plan for a helicopter fleet includes the division of demands, the matching between resources and demands, the mission assignment of the helicopter fleet and the route planning of the helicopters, there is lack of an overall optimization method for macro scheduling plans; second, there are few scheduling theories capable of being applied in the field of helicopters: some simplified assumptions are unreasonable, some fails to consider complex rescue modes such as personnel transfer, material transportation and equipment lifting, some still stay in a theoretical stage and are lack of corresponding optimization algorithms, and some fail to consider different mission capabilities of different helicopters in the fleet; third, existing route planning theories have not studied the characteristics of helicopters that have “limited duration of flight” and “require a fixed operating mode from place A to place B during transfer”.

### SUMMARY

Presently, the models and optimization methods in the field of scheduling mainly focus on a single aircraft type, single mission type, or fixed transfer mission (from place A to place B); the scheduling problem of a heterogeneous helicopter fleet involved in the present invention has the following difficulties:
1) A demand is capable of being divided into a plurality of portions, each of which may be provided with resources from various locations; transferring 100 persons from location A to location B may be assigned to a plurality of helicopters, or each helicopter may execute missions in multi-batches; therefore, it is necessary to solve the assignment problem under a situation of complex mission division;
2) Different helicopters have different cruising speeds and different abilities for executing missions; therefore, it is necessary to solve the problem relating to the mission assignment of a heterogeneous helicopter fleet based on the attributes of the helicopters;
3) Helicopters have a limited duration of flight and need to return to a base for receiving support within a specified time window; meanwhile, the execution of a transfer mission cannot be interrupted midway; therefore, it is necessary to solve the overall mission route planning problem of helicopters with limited duration of flight and fixed mission routes.

To achieve the above purpose, the present invention adopts the following technical solution: a method for hierarchically optimizing a scheduling plan of a heterogeneous helicopter fleet, comprising the steps of:
Step 1: summarizing the important information in a disaster situation, and constructing a structured input mission scenario, specifically, including the constitution of a helicopter fleet, the performance parameters of each helicopter, and the requirement of the aerial emergency rescue mission, wherein this step is capable of providing the location of resources for the aerial emergency rescue mission and the geographic location information related to the aerial emergency rescue mission;
Step 2: constructing a scheduling problem model of the heterogeneous helicopter fleet according to the input information, wherein the model is decomposed into two hierarchies including a “route planning problem model” and “a mission assignment optimization model”;
Step 3: designing data structures of solutions corresponding to the mission assignment optimization model and route planning problem model, using the mission assignment matrix as the data structure corresponding to the mission assignment optimization model, and using the helicopter mission route as the data structure corresponding to the route planning problem model;
Step 4: combining the data structures of solutions with the route planning problem model, and developing a route planning solver, wherein the solver uses the branch-and-bound algorithm and the adaptive ant-colony algorithm to perform the calculation, which is capable of determining the mission route of each helicopter according to the assignment of missions determined by the mission assignment matrix, thereby ensuring that the overall flight route of each helicopter completing all missions is the shortest;
Step 5: combining the solution data structures, the mission assignment optimization problem model and the route planning solver, developing a solver for the optimization of the mission assignment matrix; the present invention designs a heuristic operation operator of a pseudo particle swarm algorithm (PPSO) and the optimization of the mission assignment matrix is performed by this heuristic algorithm.

In another preferred embodiment of the present invention, in step 2, the optimization target function of the route planning problem model and the constraint condition formulas are as follows:

$$min {t}_{h} = {t}_{h}^{o} + {t}_{h}^{r} \qquad ( 1 )$$

$${t}_{h}^{o} = {\sum }_{n ∈ N} {\sum }_{k ∈ {K}_{nh}} {mt}_{nhk} \qquad ( 2 )$$

$${t}_{h}^{r} = ( {\sum }_{i = 0}^{i = len ( {p}_{h} ) - 1} {d}_{{p}_{h} [ i ] , {p}_{h} [ i + 1 ]} ) / {V}_{h} , ∀ h ∈ H \qquad ( 3 )$$

$${e}_{h}^{l} \geq {d}_{0 , l} / {v}_{h} , ∀ h ∈ H , ∀ l ∈ {p}_{h} \qquad ( 4 )$$

Wherein tₕ represents the time spent by a helicopter h to complete all assigned missions, wherein tₕ^{o} represents the time during which a helicopter h operates during the missions, wherein tₕ^{r} represents the time spent by a helicopter h on the way for executing the missions, wherein N represents a set of demand points, wherein Kₙₕ represents the number of missions in the mission list that a helicopter h needs to execute to meet a demand n, wherein mtₙₕₖ represents the operation time of mₙₕₖ, wherein vₕ represents the cruising speed of a helicopter, wherein H represents a set of helicopters, wherein eₕ^{l} represents the remaining duration of flight of a helicopter h at a location l, wherein d_{0,l} represents the distance between location l and a base (airport) (the location number of the base is 0), wherein pₕ represents the mission route of a helicopter h, which is also a set of locations travelled by helicopter h, wherein Pₕ[i] represents the i^{th} location on the mission route of a helicopter h, and wherein d_{Ph[i],Ph[i+1]} represents a distance between the i^{th} and i+1^{th} locations on the mission route of a helicopter h.
   In another preferred embodiment of the present invention, in step 2, the optimization target function of the mission assignment optimization model and the constraint condition formulas are as follows:

$$Minimize t = max ( {t}_{1} , {t}_{2} , … , {t}_{h} , … ) \qquad ( 5 )$$

$${mc}_{nhk} ∈ {C}_{h} , ∀ n ∈ N , ∀ h ∈ H , ∀ k ∈ {K}_{nh} \qquad ( 6 )$$

$${q}_{n} = {\sum }_{h ∈ H} {\sum }_{k ∈ {K}_{nh}} {mq}_{nhk} , ∀ n ∈ N \qquad ( 7 )$$

$${q}_{r} \geq {\sum }_{n ∈ N} {\sum }_{h ∈ H} {\sum }_{k ∈ {K}_{nh}} ( {mq}_{nhk} \cdot {mr}_{nhkr} ) , ∀ r ∈ R \qquad ( 8 )$$

$${c}_{nh} \geq {mq}_{nhk} , ∀ n ∈ N , ∀ h ∈ H , ∀ k ∈ {K}_{nh} \qquad ( 9 )$$

$${e}_{h}^{M} \geq {mt}_{nhk} + ( {d}_{0 , l 1} + {d}_{l 1 , l 2} + {d}_{l 2 , 0} ) / {v}_{h} \qquad ( 10 )$$

$$l 1 = {mpf}_{nhk} , l 2 = {mpl}_{nhk} , ∀ n ∈ N , ∀ h ∈ H , ∀ k ∈ {K}_{nh}$$

wherein tₕ represents the time spent by a helicopter h to complete all assigned missions, wherein mcₙₕₖ represents the mission type of mₙₕₖ, wherein Cₕ represents a set of mission types capable of being executed by a helicopter h, wherein Kₙₕ represents the number of missions in the mission list that a helicopter h needs to execute to meet a demand n, wherein qₙ represents the quantity of a demand n, wherein mqₙₕₖ represents the mission load of mₙₕₖ, wherein mrₙₕₖᵣ=0/1, and if mₙₕₖ is provided with resources by r, mrₙₕₖᵣ=1, wherein cₙₕ represents the maximum single mission ability of a helicopter h when executing missions with a corresponding demand n, wherein eₕ^{M} represents the maximum duration of flight of a helicopter h, wherein mtₙₕₖ represents the operation time of mₙₕₖ, wherein mpfₙₕₖ represents the first location in the mission route of mₙₕₖ, wherein mplₙₕₖ represents the first location in the mission route of mₙₕₖ.

In another preferred embodiment of the present invention, in step 3, each row of the mission assignment matrix corresponds to one helicopter, and each column of the mission assignment matrix corresponds to one demand, wherein the elements in the mission assignment matrix belong to a mission list, which represent a mission list arranged by the command center for an i^{th} helicopter (hj) to satisfy a j^{th} demand, wherein each mission in the mission list possesses four attributes including “route”, “load”, “type” and “duration of execution”, wherein the mission route of a helicopter may be expressed using a series of numbers, and wherein each number represents a city.

In another preferred embodiment of the present invention, in step 4, the route planning solver uses the adaptive ant-colony algorithm in solving process and uses the branch-and-bound algorithm to verify the best solution.
In another preferred embodiment of the present invention, the adaptive ant-colony algorithm converts the route planning of the helicopter into a problem for optimizing the route search of the ant-colony, wherein Ant represents a category, which possesses attributes including the current city lₕ, the remaining duration of flight eₕ^{l} at the current city, the route currently traveled pₕ, the total distance traveled Dₕ, and the remaining mission list ML_{Ant}, wherein the final mission routes of different Ant in Ants may be regarded as an exploration of the best mission route for helicopter h, which is a feasible mission route for the helicopter, wherein during the route exploration of the Ants, the Ant first calculates the mission selection probability pₘ_{ₙₕₖ} of mₙₕₖ in ML_{Ant}, and then selects the next mission based on the roulette principle, wherein in each cycle of the algorithm, all Ant in the Ants are initialized first, and then each Ant searches for a feasible mission route based on the heuristic rule, wherein finally, the Ant having the shortest mission route in that cycle is taken as the best Ant in that cycle of iteration.

In another preferred embodiment of the present invention, in the branch-and-bound algorithm, each node of the search tree is equivalent to an intermediate state of a helicopter during its execution of mission, which possesses four attributes including “current node route”, “time consumption of current route”, “unfinished mission list” and “remaining duration of flight”, wherein starting from a root node, the branch operation is continuously performed to generate a new generation of nodes until one branch completes all missions and the search tree generates a first end node, wherein subsequently, the search tree performs a pruning operation while stopping the growth of the intermediate node that does not meet the requirement, wherein until all descendant nodes that are newly generated become end nodes, the algorithm is completed.

In another preferred embodiment of the present invention, in step 5, the solver uses a heuristic operator of the pseudo particle swarm algorithm to complete the calculation and optimize the mission assignment matrix, comprising the steps of:
1) generating P_{size} initial mission assignment matrices, wherein each mission assignment matrix corresponds to one particle;
2) evaluating all particles, and solving the best mission routes of all helicopters corresponding to the mission assignment matrix;
3) finding a particle P_{best}, with shortest mission completion time from the particles, and moving the particle swarm;
   repeating the steps 2) and 3) for Iₘₐₓ times, outputting the best particle in the historical records, and using its corresponding mission assignment matrix as the final solution of the mission assignment solver.

Compared with the prior art, the present invention has the following advantages:
1) The present invention performs modeling for post-disaster aerial emergency rescue scenarios and defines the scheduling problem for a heterogeneous helicopter fleet; furthermore, the present invention provides a method for hierarchically optimizing a scheduling plan of a heterogeneous helicopter fleet; according to the present invention, the scheduling problem of a heterogeneous helicopter fleet is decomposed into two levels, namely, mission assignment and route planning; the optimization results of the route planning level is used as the evaluation of the mission assignment plan; therefore, a transfer mission and a heterogeneous helicopter fleet model under a large-scale natural disaster is established, and by means of decomposing the hierarchy structure, the scheduling plan of the fleet may be analyzed and optimized; through adopting the present invention, the scheduling plan is converted from a text-based plan to a data-based plan and the real-time scheduling is converted into the plan making;
2) The coding form of the mission assignment matrix is designed for helicopters with various capability attributes and mission demands, which meets the complexity of demand division and mission assignment; further, according to the present invention, an operator of the pseudo particle swarm algorithm in the process of solving the problem relating to the optimization of the mission assignment matrix is designed, so that the optimized mission division is achieved and the efficiency of making a scheduling plan is improved;
3) According to the present invention, the loading-unloading route planning problem of a helicopter under limited duration of flight is solved; meanwhile, the branch-and-bound method and the adaptive ant-colony algorithm are used for solving the problem, so that an optimized helicopter mission route is obtained, and the time spent by a helicopter for completing missions is significantly reduced;
   The benefits of the optimization method of the present invention are obvious: when a natural disaster occurs, facing high rescue complexity and high pressure, a scheduling plan optimization algorithm is capable of providing support to relevant authorities and regional navigation stations, which is helpful for making a scheduling plan of a helicopter fleet.

### BRIEF DESCRIPTION OF THE DRAWINGS

FIG. 1 is a schematic diagram illustrating a frame of the method for hierarchically optimizing a macro scheduling plan of a heterogeneous helicopter fleet;

FIG. 2 is a schematic diagram illustrating a data structure of the mission assignment matrix;

FIG. 3 is a schematic diagram illustrating an average calculation time curve of the branch-and-bound algorithm and the adaptive ant-colony algorithm when inputting different number of missions;

FIG. 4 is a schematic diagram illustrating the calculation absolute errors and relative errors of the adaptive ant-colony algorithm when inputting different number of missions;

FIG. 5 is a schematic diagram illustrating a strategy for “not best” particles to move towards the best particle in the pseudo particle swarm algorithm;

FIG. 6 is a schematic diagram illustrating a strategy for unordered variation of “not best” particles in the pseudo particle swarm algorithm;

FIG. 7 is a schematic diagram illustrating the final helicopter mission route corresponding to a calculation example.

### DETAILED DESCRIPTION

To make the purpose and technical solution of the present invention clearer, drawings are combined hereinafter to elaborate the techniques of the present invention. It should be understood that the embodiments described herein are merely intended to explain but not limit the present invention.

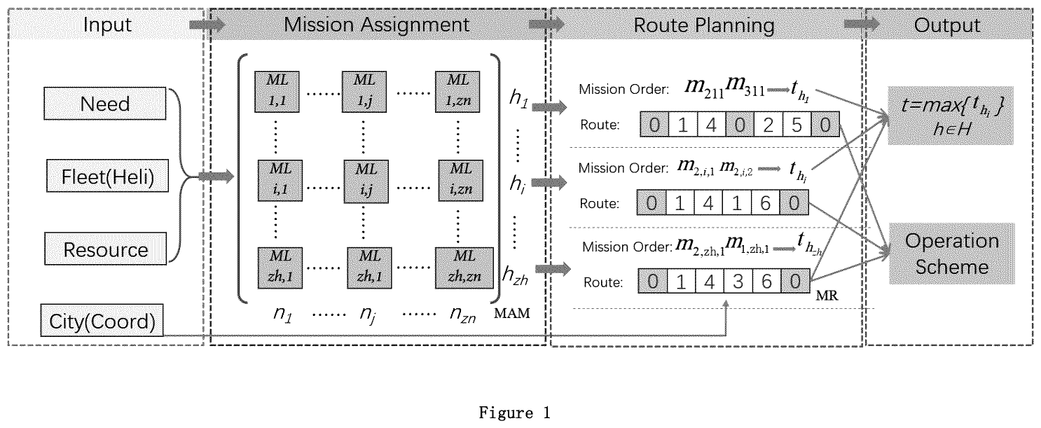

The present invention provides a method for hierarchically optimizing a macro scheduling plan of a heterogeneous helicopter fleet. As shown in FIG. 1, the specific flow of the method comprising the steps of:
Step 1: summarizing the important information in a disaster situation, and constructing a structured input mission scenario, specifically, including the constitution of a helicopter fleet, the performance parameters of each helicopter, and the requirement of the aerial emergency rescue mission, wherein this step is capable of providing the location of resources for the aerial emergency rescue mission and the geographic location information related to the aerial emergency rescue mission;
Step 2: constructing a scheduling problem model of the heterogeneous helicopter fleet according to the input information, wherein the model is decomposed into two hierarchies including a “route planning problem model” and “a mission assignment optimization model”, and when embodied as a mathematical formula, the model includes an optimization target function, a constraint condition formula, and all used variable parameters, wherein the parameters include helicopters, demand points, a set of resource points and attributes thereof;
Step 3: designing the data structures of solutions corresponding to the problem model, wherein because the problem model is decomposed into two hierarchies including the “mission assignment” and “route planning”, corresponding design data structures are required; in the present invention, to exhibit the complex situation of the mission assignment of a heterogeneous helicopter fleet, a “mission assignment matrix” is used as an optimization object (data structure) corresponding to the mission assignment, and the “helicopter route” is used as an optimization object (data structure) corresponding to the “route planning”;
Step 4: combining the data structures of solutions with the route planning problem model, and developing a route planning solver, wherein the solver may determine the mission route of each helicopter according to the mission assignment determined by the mission assignment matrix, thereby minimizing the overall flight route of a helicopter completing all missions, wherein in the present invention, the calculation is completed by adopting a branch-and-bound algorithm and an adaptive ant-colony algorithm;
Step 5: combining the solution data structures, the mission assignment optimization problem model and the route planning solver, developing a solver for the optimization of the mission assignment matrix; the present invention designs a heuristic operation operator of a pseudo particle swarm algorithm (PPSO) and the optimization of the mission assignment matrix is performed by this heuristic algorithm;

The ideas, difficulties, and differences in the technical solution are described in details in the following:

In step 2, a scheduling problem model of the heterogeneous helicopter fleet is constructed according to the input information, and the model is decomposed into two hierarchies including a “route planning problem model” and “a mission assignment optimization model”. The parameter table required by the problem model is shown in below:
Step 2.1: The variable parameter table used for modeling:

TABLE 1
The Variable Parameter Table

| | |
|---|---|
| Set: | |
| H | A set of Helicopters |
| N | A set of demand points |
| R | A set of resource points |
| L | A set of locations |
| M | A set of missions |
| Cₕ | A set of missions executed by a helicopter h; |
| Cᵣ | A set of resources provided by a resource point r; |
| MLₙ | A list of missions that need to be executed |
| | to meet a requirement n; |
| MLₕ | A set of missions of a helicopter h; |
| MLₕₙ | A list of missions that a helicopter h needs |
| | to perform to meet a |
| | requirement n; |
| MAM | A mission assignment matrix; |
| Parameters: | |
| zn | The quantity of demand |
| zh | The quantity of helicopters |
| d_{l1, l2} | A distance (km) between locations l1 and l2; |
| qₙ | The mission quantity of a requirement n; |
| qᵣ | The resource quantity provided by a resource r; |
| vₕ | The speed (km/h) of a helicopter h; |
| lₕ | A city where a helicopter h stays in; |
| Dₕ | A total distance traveled by a helicopter h; |
| cₙₕ | The maximum single mission ability of a helicopter |
| | h when executing missions with a |
| | corresponding demand n; |
| eₕ^{m} | Maximum range of a helicopter h; |
| pₕ | The mission route of is a set of locations |
| | that a helicopter h passes by; |
| t | The duration that all missions are completed; |
| tₕ | The duration for a helicopter h to complete |
| | all allocated missions; |
| tₕ^{o} | The duration that a helicopter h operates |
| | during a mission; |
| tₕ^{r} | The duration that a helicopter h spent on |
| | the way for executing the mission; |
| Kₙₕ | The number of missions in the mission list that |
| | a helicopter h needs to execute to meet a demand n; |
| mₙₕₖ | The kth mission in the mission list that a |
| | helicopter h needs to execute to meet a demand n; |
| mcₙₕₖ | The type of missions of mₙₕₖ; |
| mqₙₕₖ | The load of missions of mₙₕₖ; |
| mtₙₕₖ | The operating hours of mₙₕₖ; |
| mpₙₕₖ | The mission route of mₙₕₖ, |
| mpfₙₕₖ | The first location in the mission route of mₙₕₖ; |
| mplₙₕₖ | The second location in the mission route of mₙₕₖ; |
| Special variable: | |
| mrₙₕₖᵣ | mrₙₕₖᵣ = 0/1, and if mₙₕₖis provided |
| | with resources by r, |
| | mrₕₙₖᵣ = 1 |
| eₕ^{l} | Remaining duration of flight l ∈ Pₕ of a helicopter |
| | h in one hour; |

Step 2.2: the optimization target function of the route planning problem model and the constraint condition formulas are as follows:

$$min {t}_{h} = {t}_{h}^{o} + {t}_{h}^{r} \qquad ( 11 )$$

$${t}_{h}^{o} = {\sum }_{n ∈ N} {\sum }_{k ∈ {K}_{nh}} {mt}_{nhk} \qquad ( 12 )$$

$${t}_{h}^{r} = ( {\sum }_{i = 0}^{i = len ( {p}_{h} ) - 1} {d}_{{p}_{h} [ i ] , {p}_{h} [ i + 1 ]} ) / {V}_{h} , ∀ h ∈ H \qquad ( 13 )$$

$${e}_{h}^{l} \geq {d}_{0 , l} / {v}_{h} , ∀ h ∈ H , ∀ l ∈ {p}_{h} \qquad ( 14 )$$

wherein formula (1) is a target function of the route planning problem model, representing the duration that a helicopter h completes all missions, including the duration that the helicopter h executes the missions and the duration that the helicopter h spends on the way for executing the missions, wherein formula (2) stipulates that the sum of the duration that the helicopter h operates during the missions is equal to the sum of the durations that helicopter h operates for executing all assigned missions mₙₕₖ, wherein formula (3) illustrates that, the duration that helicopter h spends on the road during the missions is equal to a value that the length of the mission route is divided by the speed of the helicopter, wherein formula (4) ensures that there is enough fuel for the helicopter to return to the base for refueling and support at any point in the mission route;
wherein formula (5) is an optimization target of the mission assignment matrix, namely, minimizing the maximum value that all the helicopters spend for completing their missions, wherein tₕ is an best value of the route planning problem model in the previous section, wherein formula (6) ensures that the command center assigns corresponding types of missions to the helicopter h based on its mission capability, wherein formula (7) illustrates that the total demand of a demand n is equal to the sum of the loads of the relevant missions mₙₕₖ such that the demand is satisfied, wherein formula (8) ensures that, the resources that the command center requires the resource point r to provide do not exceed the maximum amount of resources that resource point r is capable of providing, wherein formula (9) requires that the mission load of a helicopter during each mission does not exceed its maximum mission capacity, wherein formula (10) is the feasibility constraint of mission assignment, ensuring that any mission assigned to helicopter h must be completed within one dispatch of helicopter h;

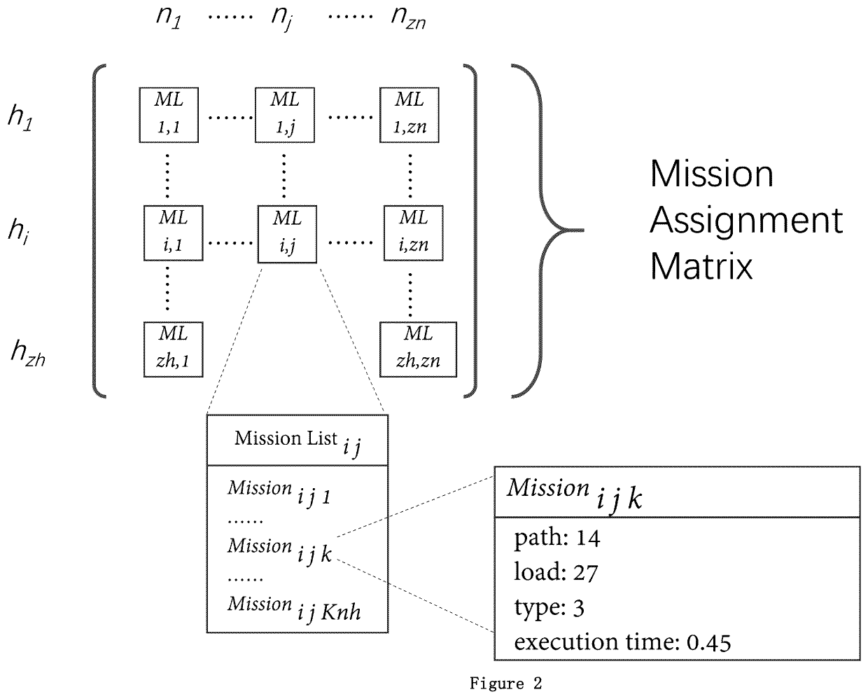

In step 3, a mission assignment matrix and data structures of the mission route of a helicopter are mainly designed;
Step 3.1: as shown in FIG. 2, each row of the mission assignment matrix corresponds to one helicopter, and each column of the mission assignment matrix corresponds to one demand; the elements in the mission assignment matrix belong to a mission list, which represent a mission list arranged by the command center for an i^{th} helicopter (hj) to satisfy a j^{th} demand; each mission in the mission list possesses four attributes including “route”, “load”, “type” and “duration of execution”; the structure of the mission assignment matrix may adapt to mixed fleets, various mission types and demand decomposition with highly flexible requirement;
Step 2.3: the optimization target function of the mission assignment optimization model and the constraint condition formulas are as follows:

$$Minimize t = max ( {t}_{1} , {t}_{2} , … , {t}_{h} , … ) \qquad ( 15 )$$

$${mc}_{nhk} ∈ {C}_{h} , ∀ n ∈ N , ∀ h ∈ H , ∀ k ∈ {K}_{nh} \qquad ( 16 )$$

$${q}_{n} = {\sum }_{h ∈ H} {\sum }_{k ∈ {K}_{nh}} {mq}_{nhk} , ∀ n ∈ N \qquad ( 17 )$$

$${q}_{r} \geq {\sum }_{n ∈ N} {\sum }_{h ∈ H} {\sum }_{k ∈ {K}_{nh}} ( {mq}_{nhk} \cdot {mr}_{nhkr} ) , ∀ r ∈ R \qquad ( 18 )$$

$${c}_{nh} \geq {mq}_{nhk} , ∀ n ∈ N , ∀ h ∈ H , ∀ k ∈ {K}_{nh} \qquad ( 19 )$$

$${e}_{h}^{M} \geq {mt}_{nhk} + ( {d}_{0 , l 1} + {d}_{l 1 , l 2} + {d}_{l 2 , 0} ) / {v}_{h} \qquad ( 20 )$$

$$l 1 = {mpf}_{nhk} , l 2 = {mpl}_{nhk} , ∀ n ∈ N , ∀ h ∈ H , ∀ k ∈ {K}_{nh}$$

Step 3.2: the mission route of a helicopter may be expressed using a series of numbers, such as “013065120”, wherein each number represents a city;

In step 4, it is necessary to determine that the mission route of a helicopter completing all missions is the shortest; for one helicopter, if the mission list required to be completed is determined, it is certain that it completes all missions in a best route; subsequently, due to the background of the rescue mission, new constraints need to be added:
1. Helicopters are restricted by the fuel quantity and the remaining duration of flight, which is equivalent to a vehicle routing problem with a hard time window (VRPTW);
2. When a helicopter executes a mission, it needs to pass through two locations instead of reaching a single location in a traditional VRP; when performing material transportation missions, the helicopter needs to load the materials at a warehouse first and then transport them to a disaster area;

Aiming at the aforesaid difficulties (two special constraints), the technical solutions of the two algorithms for solving the route planning problem and a consideration on how to select the two algorithms are described as below:
Step 4.1: designing an improved branch-and-bound algorithm to obtain an accurate solution for the route planning, wherein the branch-and-bound algorithm is a traversal algorithm; during the execution, continuously dividing all feasible solution spaces into smaller and smaller subsets, namely, branches, and calculating a lower bound or an upper bound for the value of the solution within each branch; further, during the exploration, performing the pruning according to the existing best value and the upper and lower bounds of the branch using the algorithm, thereby reducing the solution space that needs to be explored while accelerating the completion of the traversal;

The parameter table used in the present invention is as follows:

| | |
|---|---|
| MLₕ | A set of missions of a helicopter h |
| Bₜ | The duration for the current best route |
| Bᵣ | The current best route |
| F | A set of feasible mission routes |
| beginCut | State value, given a value of True when the search |
| | tree generates a first complete route |
| node | Node, a basic structure of a search tree |
| iniNode | Initial node, the node path is base code 0, |
| | and the node value is 0 |
| endNote | End node, forms a feasible mission route from |
| | the root node to the branch |
| tempNodes | A set of all possible nodes generated |
| | downwards from a node |
| newNodes | A set of newly generated nodes, all sets of tempNodes |
| | generated by the first-generation nodes |

wherein each node of the search tree is equivalent to an intermediate state of a helicopter during its execution of mission, which possesses four attributes including “current node route”, “time consumption of current route”, “unfinished mission list” and “remaining duration of flight”; starting from a root node, the branch operation is continuously performed to generate a new generation of nodes until one branch completes all missions and the search tree generates a first end node; subsequently, the search tree performs a pruning operation while stopping the growth of the intermediate node that does not meet the requirement; until all descendant nodes that are newly generated become end nodes, the algorithm is completed;

The advantage of the branch-and-bound algorithm is that it is capable of ensuring a best solution; however, due to the idea of traversal, the branch-and-bound algorithm has a poor ability in calculation; for example, when the number of missions exceeds 9, a computer with a memory of 16 GB fails to complete the calculation;
Step 4.2: designing an improved adaptive ant-colony algorithm to obtain an approximate solution for the route planning with low calculated amount, wherein this algorithm and the branch-and-bound algorithm may cooperate with each other; According to the present invention, ant objects are designed, a parametric modeling is performed, and the route planning of the helicopter is converted into a problem for optimizing the route search of the ant-colony, wherein Ant represents a category, which possesses attributes including the current city lₕ, the remaining duration of flight eₕ^{l} at the current city, the route currently traveled pₕ, the total distance traveled Dh, and the remaining mission list ML_{Ant}; the final mission routes of different Ant in Ants may be regarded as an exploration of the best mission route for helicopter h, which is a feasible mission route for the helicopter; all parameters and their explanations required for the adaptive ant-colony algorithm are shown in the table below:

TABLE 3
Parameters Used in the Adaptive Ant-colony Algorithm

| | |
|---|---|
| α | An information heuristic factor |
| β | An expectation heuristic factor |
| ρ | A pheromone volatilization factor |
| Q | The sum of pheromone increments of each iteration |
| Cₘₐₓ | The maximum number of iterations of the algorithm |
| a | The number of ant colonies |
| Pₘ | A pheromone matrix |
| Ant | The data structure of the algorithm |
| Ants | A set of ant colonies |
| ML_{Ant} | A mission list of an Ant |
| lₕ | A city where an Ant is located |
| Dₕ | The total distance traveled by an Ant |
| pₘ_{ₙₕₖ} | The probability of selecting mission mₙₕₖfrom |
| | ML_{Ant} by an Ant |
| Bₐ^{c} | The best ant in each iteration of the algorithm |
| G_{B} | A set saving the best ant in each generation |
| Bₐ | The best ant ultimately selected by the algorithm |

The process of performing a route exploration by Ants is similar to the process of unceasingly searching for a next node in the branch-and-bound method, but the difference lies in the process of selecting a next mission by an Ant; the Ant first calculates the mission selection probability pₘ_{ₙₕₖ} of mₙₕₖ in ML_{Ant}, and then selects the next mission based on the roulette principle; in each cycle of the algorithm, all Ant in the Ants are initialized first, and then each Ant searches for a feasible mission route based on the heuristic rule; finally, the Ant having the shortest mission route in that cycle is taken as the best Ant in that cycle of iteration;

Compared with the traditional ant-colony algorithm, the main improvements of the ant-colony algorithm adopted in the present invention are as follows:

According to the constraints of the remaining duration of flight in the model, time windows are set at all locations in the mission route; these time windows require an Ant to ensure that it is capable of returning to the base within the remaining duration of flight;

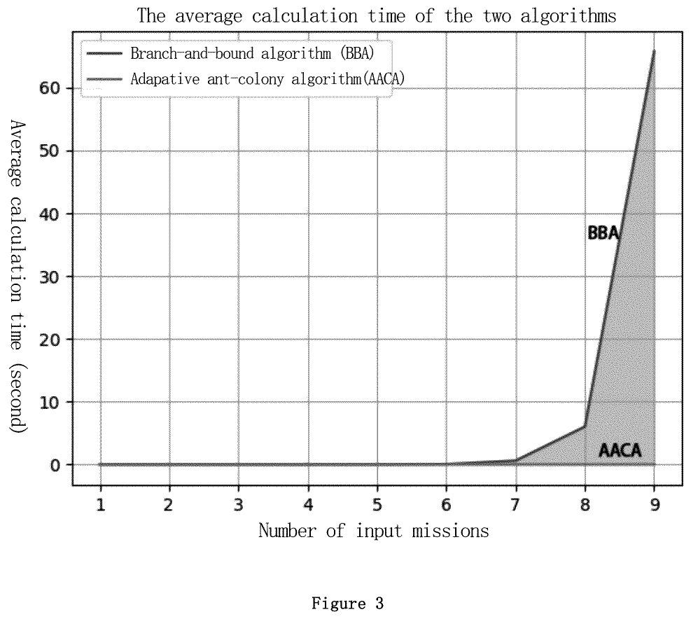

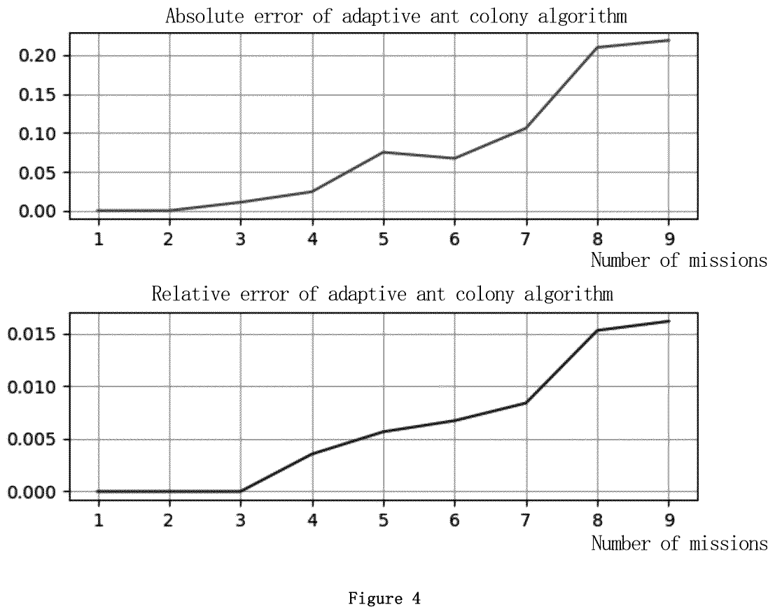

The min-max method is used for setting dynamic upper and lower limits for the pheromone on the route, thereby ensuring the search ability of the heuristic algorithm while preventing the algorithm from prematurely converging to a local best solution;
Step 4.3: determining the different timing of using the algorithm: as shown in FIG. 3, when the number of missions input into the algorithm increases, the calculating time of the branch-and-bound algorithm (BBA) increases exponentially; when the number of input missions is 10, the computer for testing fails to complete the calculation due to the limited memory (RAM=16 GB); compared with the branch-and-bound algorithm (BBA), the performance of the adaptive ant-colony algorithm (AACA) varies slightly along the increase of the number of missions, and the calculating time of the adaptive ant-colony algorithm (AACA) increases linearly from 0.003 s for one mission to 0.014 s for nine missions; as shown in FIG. 4, for the branch-and-bound algorithm (BBA) is a traversal algorithm, its output must be a global best solution; based on this, the calculation errors of the adaptive ant-colony algorithm (AACA) is observed, namely, to average the calculation errors occurring in 100 tests in each mission to observe the error condition of the adaptive ant-colony algorithm (AACA); both the absolute errors and the relative errors of the error condition of the adaptive ant-colony algorithm (AACA) increase along the increase of the number of missions; however, from the examples, the magnitude of the relative errors always remains around 0.01, namely, staying within an acceptable range; combining the calculating accuracy and the calculating time of the two algorithms, the adaptive ant-colony algorithm (AACA) has a shorter calculating time and its loss of accuracy is within an acceptable range; therefore, the adaptive ant-colony algorithm (AACA) is capable of being used in the model solving process for accelerating the speed of the model; when verifying the best solution, the branch-and-bound algorithm (BBA) with high accuracy is adopted (when the number of missions does not exceed 9);
Step 5: finally, developing a solver for optimizing the mission assignment matrix through combining a solution data structure, a mission assignment optimization problem model and a route planning solver; the following illustrates a heuristic operator of a pseudo particle swarm optimization algorithm and a technical solution for optimizing the mission assignment matrix using this heuristic algorithm: compared with a standard particle swarm optimization (PSO), the pseudo particle swarm optimization algorithm used in the present invention is capable of simplifying many parameters, such as the individual extremum and particle velocity, etc., which mainly follows an idea of “moving towards the best particle” in the PSO; let's assume that the reason why the current best particle P_{best} is the best is that its mission assignment structure is reasonable and capable of relatively exerting the best performance of the system; therefore, the mission assignment matrix of the “not best particle” P_{not best} is adjusted following the mission assignment matrix of the “best particle” P_{best}, and the adjustment method is to integrally replace a mission assignment plan needed by the aerial emergency rescue;
   The following is an embodiment of the present invention, which describes the method for hierarchically optimizing a scheduling plan of a heterogeneous helicopter fleet of the present invention in details when facing a large-scale natural disaster:

### Embodiment 1

Step 1: inputting mission scenario information for modeling, wherein the attributes that must be determined by the four types of objects contained in the mission scenario information, comprising:
Step 1.1: inputting performance parameters of each helicopter, including the cruising speed, fuel consumption, maximum oil load, maximum duration of flight, whether it is able to hang large equipment up, maximum material load and maximum passenger capacity;

TABLE 4
Performance Parameters of the Helicopter

| | Type 1 | Type 2 |
|---|---|---|
| Cruising speed | 255 | 251 |
| Fuel consumption | 3000 | 1065 |
| Maximum oil load | 12000 | 3500 |
| Maximum duration of flight | 4 | 3.3 |
| Whether it is able to hang large | 1 | 0 |
| equipment up | | |
| Maximum material load | 20000 | 4000 |
| Maximum passenger capacity | 82 | 27 |

Step 1.2: inputting the aerial emergency rescue demand information including the location of a demand point (geographic location number), demand type and demand quantity;

| Location | Need Type | Quantity |
|---|---|---|
| 2 | grab | 1 |
| 4 | supplies | 2000 |
| 2 | Send out people | 80 |
| 5 | supplies | 3000 |
| 5 | rescuer | 140 |
| 6 | supplies | 2000 |
| 6 | Send out people | 100 |
| 6 | grab | 1 |
| 7 | supplies | 3000 |

Step 1.3: inputting the serial emergency rescue resource information, including a resource point location (a geographic location number), a resource type and a resource stock;

TABLE 6
Aerial Emergency Rescue Resource Information

| Location | Supply Type | Stock |
|---|---|---|
| 1 | grabs | 2.00 |
| 1 | supplies | 5000 |
| 1 | rescuer | 40 |
| 3 | supplies | 2000 |
| 3 | rescuer | 250 |
| 3 | Settlements | 10000 |
| 3 | grabs | 2.00 |
| 8 | grabs | 4.00 |
| 8 | supplies | 5500 |
| 8 | Settlements | 10000 |

Step 1.4: inputting the geographic location information, including a location name, a location number, the longitude of a location and the latitude of a location;

TABLE 7
Geographic Location Information

| Name | Code | Longitude | Latitude |
|---|---|---|---|
| Yiwu Airport | 0 | 120.03 | 29.34 |
| Ninghai | 1 | 121.41 | 29.28 |
| Pan'an | 2 | 120.45 | 29.05 |
| Jinyun | 3 | 120.09 | 28.65 |
| Leqing | 4 | 120.97 | 28.11 |
| Tiantai | 5 | 120.98 | 29.17 |
| Xianju | 6 | 120.71 | 28.85 |
| Taizhou | 7 | 121.42 | 28.65 |
| Wenzhou | 8 | 120.70 | 28.00 |

Step 2: using a pseudo-particle swarm algorithm to perform a first-level optimization, namely, optimization of a mission assignment solution; the parameter table of the initialization system (obtained according to the debugging experience in the development process of the present invention) is as follows:

TABLE 8
Initialized System Parameters of the
Pseudo-particle Swarm Algorithm

| Parameter | Value | Meaning |
|---|---|---|
| P_{size} | 50 | Number of particle swarms |
| Iₘₐₓ | 80 | Maximum number of iterations |
| σ | 0.9 | The learning rate, the “not best” particles in |
| | | the particle swarm move to the best particle |
| | | at a probability of A. |

Step 2 further comprising the steps of:
Step 2.1: generating P_{size} initial mission assignment matrices, wherein each mission assignment matrix corresponds to one particle; the generation of the mission assignment matrix includes two levels, wherein the first level is to decompose the demand, namely, to find a resource supply point for a demand point, and the second level is the mission assignment, namely, to dispatch a helicopter to complete a transfer mission of a “demand-resource” pair generated in the first level;

Combining the characteristics of different helicopters having different capacities when executing different missions, the present invention adopts an algorithm capable of simplifying the generation of mission assignment matrices; for each demand, a helicopter with relevant operational capabilities is randomly selected, and a resource point with relevant resources is randomly selected as well; the mission load of this mission is set to the minimum value among the three values including the “the load of a helicopter executing a single mission”, “residual demand” and “residual resource”;
Step 2.2: evaluating all particles (corresponding to a mission assignment matrix), wherein the evaluation process is actually used for solving the best mission routes of all helicopters corresponding to the mission assignment matrix; to obtain the maximum duration for all helicopters completing the missions, this time value is used as a value for evaluating the mission assignment matrix (the timeliness of the entire scheduling plan);

Therefore, it is necessary to enter the second level and developing a solver for optimizing the path planning;
Step 2.2.1: adopting an adaptive ant-colony algorithm to initialize the system parameters (obtained according to debugging experience in the development process of the present invention), and generating Ants according to the number of ant colonies;

TABLE 9
Initialized System Parameters of Adaptive Ant-colony Algorithm

| Parameter | Value | Meaning |
|---|---|---|
| α | 1 | An information heuristic factor |
| β | 0 | An expectation heuristic factor |
| ρ | 0.5 | A pheromone volatilization factor |
| Q | 1000 | The sum of pheromone increments of |
| | | each iteration |
| Cₘₐₓ | 10 | The maximum number of iterations of |
| | | the algorithm |
| a | 2 | The number of ant colonies |

Step 2.2.2: updating all Ant objects to an initial state, wherein lₕ is a base (the city code is 0);
Step 2.2.3: for each Ant, selecting the node of a next mission and executing the mission, and updating the state until its ML_{Ant} becomes an empty set; first, calculating the probability of selecting the next mission based on the probability selection formula by an Ant; before using the formula, it is important to verify the remaining duration of flight of the helicopter first, namely, ensuring that the remaining fuel in the helicopter allows it to return to the base after executing the next mission; at this point, the mission is reachable;
   the probability of mission selection is pₘ_{ₙₕₖ}=0; normally, the formula for calculating the probability pₘ_{ₙₕₖ} of mission selection is as follows:

$$( 21 )$$

$${p}_{{m}_{nhk}} = \{ \begin{matrix}\frac{{( {P}_{m} [ {l}_{h} ] [ {mpf}_{nhk} ] + {P}_{m} [ {mpf}_{nhk} ] [ {mpl}_{nhk} ] )}^{a}}{{( {d}_{{l}_{h} , {mpf}_{nhk}} + {d}_{{mpf}_{nhk} , {mpl}_{nhk}} )}^{b}} & if {m}_{nhk} is reachable \\ 0 & if {m}_{nhk} is not reachable\end{matrix}$$

Subsequently, letting the Ant draw lots from all reachable missions based on the principle of roulette, obtaining a next mission node and executing this mission, updating its own status including ML_{Ant}, lₕ, and Dₕ, and repeating the aforesaid mission selection process until all Ant complete all missions;
Step 2.2.4: updating the pheromone matrix Pₘ; selecting the best ant Bₐ^{c} with the shortest route from the ant colony Ants and putting it into G_{B}; meanwhile, according to the pheromone matrix Pₘ of the updated algorithm of Bₐ^{c} (the update is based on simulating the pheromones left by the ants), marking the route traveled by Bₐ^{c}, thereby improving the probability of selecting the shortest route, wherein Pₘ represents an accumulation of the iterative experience throughout the entire algorithmic process, wherein the formula for updating the pheromone is as follows:

$${P}_{m} [ {p}_{h}^{z} ] [ {p}_{h}^{z + 1} ] = {P}_{m} [ {p}_{h}^{z} ] [ {p}_{h}^{z + 1} ] * r + Q / {D}_{{B}_{a}^{c}} \qquad ( 22 )$$

Step 2.2.5: dynamically and adaptively adjusting the values in the pheromone matrix Pₘ, obtaining the maximum value aa in Pₘ, reducing the pheromone values greater than 0.8*aa in the matrix to 0.8*aa, and increasing the pheromone values lower than 0.2*aa in the matrix to 0.2*aa; this step is capable of ensuring that the pheromone matrix does not converge prematurely, thereby optimizing the scope of exploration while improving the accuracy of the algorithm;
Step 2.2.6: repeating the process of an ant colony exploring and updating the pheromone matrix for Cₘₐₓ times, recording the best ant during the process, and outputting its mission route as the final solution, wherein at this point, the calling process of the adaptive ant-colony algorithm is completed;
Step 2.3: after completing the evaluation of all particles, finding a particle P_{best} with the highest score (shortest mission completion time and best timeliness) from the particles, and then moving the particle swarm, wherein the overall movement strategy of the particle swarm is:

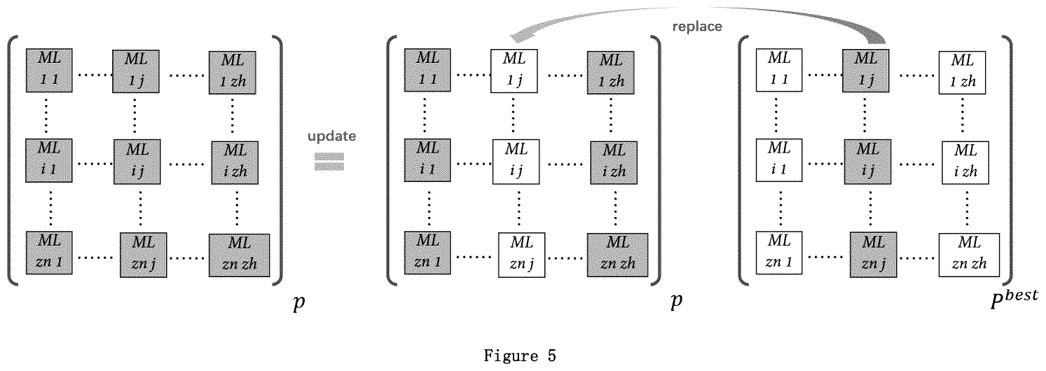

At a certain learning rate σ, the mission assignment matrix of the “not best” particles is adjusted following the mission assignment matrix of the best particle P_{best}, wherein the specific operation process is shown in FIG. 5, wherein its macro meaning is that the “not best” particles P_{not best} randomly select a mission assignment solution of a demand (corresponding to a column of the mission assignment matrix) from the mission assignment matrix, and replace the assignment solution corresponding to this demand in their own (P_{not best}) mission assignment matrix;

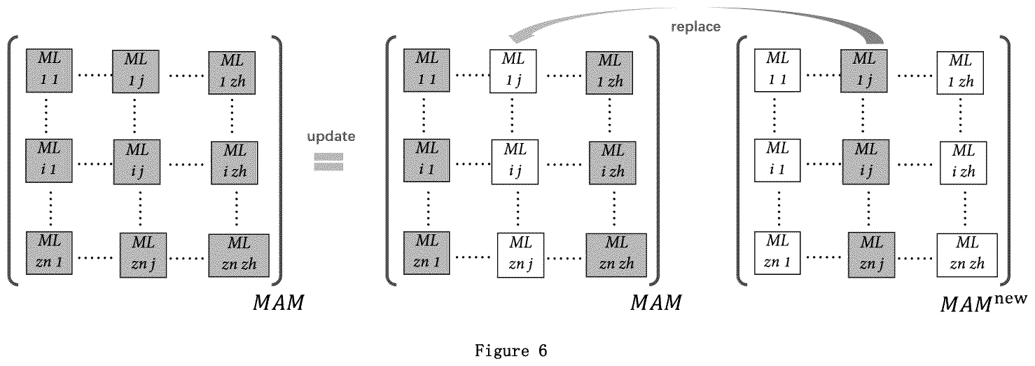

Otherwise, P_{not best} performs an unordered variation, wherein the mutation operator is shown in FIG. 6, wherein its macroscopic meaning is to re-generate a new mission assignment matrix MAM^{new}, wherein the “not best” particles P_{not best} randomly select a mission assignment solution of a demand (corresponding to a column of the mission assignment matrix) from the mission assignment matrix of MAM^{new}, and replace the assignment solution corresponding to this demand in their own (P_{not best}) mission assignment matrix;
Step 2.4: repeating the steps 2.2-2.3 for Iₘₐₓ times, outputting the best particle in the historical records, and using its corresponding mission assignment matrix as the final solution of the mission assignment solver;
Step 3: based on the optimized mission assignment matrix, solving the corresponding scheduling plan for the helicopter fleet, namely, obtaining the mission sequence (route) of each helicopter, wherein the branch-and-bound algorithm may be used to obtain an accurate solution;
Step 3.1: initializing to make Bₜ=1000, wherein F is an empty set, generating initial nodes, and making nodes={iniNode}, wherein the nodes are the set of nodes that need to be grown for each generation;
Step 3.2: determining if the nodes are an empty set; if so, entering step 3.5, and if not, entering step 3.3;
Step 3.3: generating a new generation of nodes for each node in the nodes; first, determining the set of unfinished missions in a node state, and judging whether these missions are reachable in the current node state, wherein the standard of “reachable” is that, after completing the missions, a helicopter is able to return to a base for receiving support, wherein it should be understood that, at each node, it is always capable of generating a node corresponding to “returning to a base for receiving support”; finally, adding tempNodes into newNodes as a new generation of nodes;
Step 3.4: determining whether an end node is generated in the newly generated first-generation nodes newNodes; if so, entering step 3.4.1, and if not, entering step 3.2;
Step 3.4.1: putting the mission route corresponding to the end node endNote into F, thereby obtaining the time Bₜ corresponding to the best mission route (corresponding to the shortest time) in F; subsequently, determining the time of mission routes corresponding to all nodes in the current new generation of nodes newNodes: if there is an intermediate node at which a helicopter has not yet completed all missions but the corresponding time spent on the mission route is already greater than Bₜ, it can be inferred that the end node growing from that node cannot obtain a solution better than Bₜ; therefore, pruning is performed to delete the node; subsequently, assigning newNodes values to the nodes after pruning the nodes failing to meet the demand, and entering step 3.2;
Step 3.5: outputting the best route Bᵣ in F and its corresponding time Bₜ as the final solution of the branch-and-bound solver, thereby completing the algorithm;
Step 4: outputting the current best mission assignment matrix and the corresponding best mission route (sequence) of each helicopter, thereby completing the optimization process;

Here are the optimization results corresponding to the mission scenarios:

The final mission assignment matrix is converted into a table as follows:

TABLE 10
Table of The Best Mission Assignment

| | Helicopter | Mission | Mission | Mission |
|---|---|---|---|---|
| | Name | Type | Route | Load |
| 0 | h1(Type 2) | 3 | 34 | 2000 |
| 1 | h1(Type 2) | 5 | 23 | 27 |
| 2 | h1(Type 2) | 4 | 35 | 27 |
| 3 | h1(Type 2) | 4 | 15 | 13 |
| 4 | h1(Type 2) | 5 | 63 | 27 |
| 5 | h1(Type 2) | 3 | 87 | 3000 |
| 6 | h2(Type 2) | 3 | 15 | 3000 |
| 7 | h2(Type 2) | 4 | 15 | 27 |
| 8 | h2(Type 2) | 3 | 86 | 2000 |
| 9 | h2(Type 2) | 5 | 63 | 27 |
| 10 | h2(Type 2) | 5 | 63 | 27 |
| 11 | h2(Type 2) | 5 | 68 | 19 |
| 12 | h3(Type 1) | 2 | 32 | 1 |
| 13 | h3(Type 1) | 5 | 28 | 53 |
| 14 | h3(Type 1) | 4 | 35 | 73 |
| 15 | h3(Type 1) | 2 | 86 | 1 |

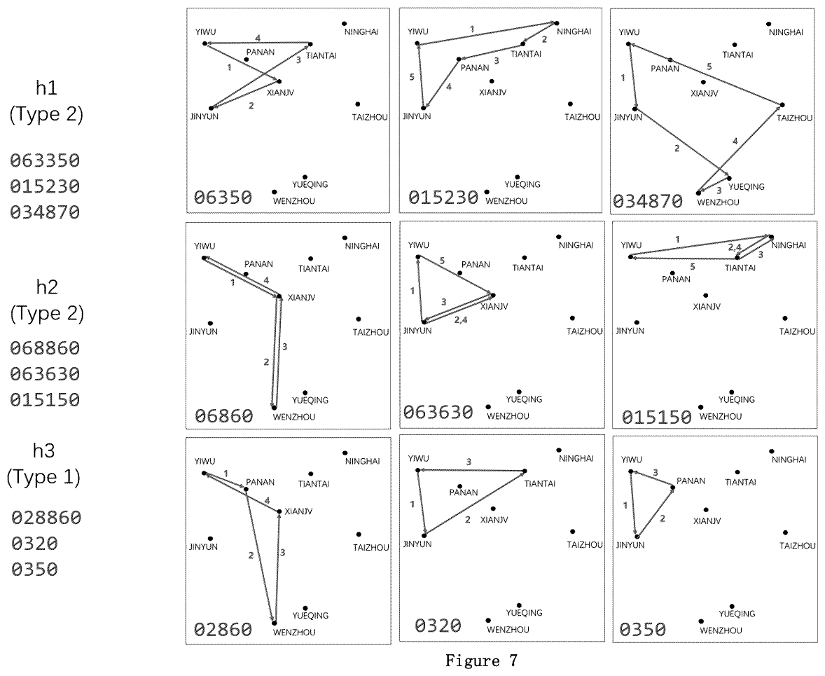

The final mission route of each helicopter is shown in FIG. 7:

The total time consumption for each helicopter to execute missions is:

TABLE 11
Total Time Consumption for Each Helicopter to Execute Missions

| | h1(Type 2) | h2(Type 2) | h3(Type 1) |
|---|---|---|---|
| Mission Route | 0633501523034870 | 0688606363015150 | 028860320350 |
| Total Time | 9.688506906 | 9.463470399 | 9.321607074 |
| Consumption | | | |
| (h) | | | |

1. A method for hierarchically optimizing a scheduling plan of a heterogeneous helicopter fleet, comprising the steps of:
step 1: summarizing information in a disaster situation, and constructing a structured input mission scenario, wherein the information comprising the constitution of a helicopter fleet, the performance parameters of each helicopter, and the requirement of the aerial emergency rescue mission,
step 2: constructing a scheduling problem model of the heterogeneous helicopter fleet according to the input information, wherein the model is decomposed into two hierarchies including a route planning problem model and a mission assignment optimization model;
step 3: designing data structures of solutions corresponding to the mission assignment optimization model and route planning problem model, using the mission assignment matrix as the data structure corresponding to the mission assignment optimization model, and using the helicopter mission route as the data structure corresponding to the route planning problem model;
step 4: combining the data structures of solutions with the route planning problem model, and developing a route planning solver, wherein the solver uses the branch-and-bound algorithm and the adaptive ant-colony algorithm to perform the calculation, which is capable of determining the mission route of each helicopter according to the assignment of missions determined by the mission assignment matrix, thereby ensuring that the overall flight route of each helicopter completing all missions is the shortest;
step 5: combining the solution data structures, the mission assignment optimization problem model and the route planning solver, developing a solver for the optimization of the mission assignment matrix; the present invention designs a heuristic operation operator of a pseudo particle swarm algorithm and the optimization of the mission assignment matrix is performed by this heuristic algorithm.

2. The method for hierarchically optimizing a scheduling plan of a heterogeneous helicopter fleet of claim 1, wherein in step 2, the optimization target function of the route planning problem model and the constraint condition formulas are as follows:
$$min {t}_{h} = {t}_{h}^{o} + {t}_{h}^{r} \qquad ( 11 )$$
$${t}_{h}^{o} = {\sum }_{n ∈ N} {\sum }_{k ∈ {K}_{nh}} {mt}_{nhk} \qquad ( 12 )$$
$${t}_{h}^{r} = ( {\sum }_{i = 0}^{i = len ( {p}_{h} ) - 1} {d}_{{p}_{h} [ i ] , {p}_{h} [ i + 1 ]} ) / {V}_{h} , ∀ h ∈ H \qquad ( 13 )$$
$${e}_{h}^{l} \geq {d}_{0 , l} / {v}_{h} , ∀ h ∈ H , ∀ l ∈ {p}_{h} \qquad ( 14 )$$
wherein tₕ represents the time spent by a helicopter h to complete all assigned missions, wherein tₕ^{o} represents the time during which a helicopter h operates during the missions, wherein tₕ^{r} represents the time spent by a helicopter h on the way for executing the missions, wherein N represents a set of demand points, wherein Kₙₕ represents the number of missions in the mission list that a helicopter h needs to execute to meet a demand n, wherein mtₙₕₖ represents the operation time of mₙₕₖ, wherein vₕ represents the cruising speed of a helicopter, wherein H represents a set of helicopters, wherein eₕ^{l} represents the remaining duration of flight of a helicopter h at a location l, wherein d_{0,l} represents the distance between location land a base (airport) (the location number of the base is 0), wherein pₕ represents the mission route of a helicopter h, which is also a set of locations travelled by helicopter h, wherein Pₕ[i] represents the i^{th} location on the mission route of a helicopter h, and wherein d_{Ph[i],Ph[i+1]} represents a distance between the i^{th} and i+1^{th} locations on the mission route of a helicopter h.

3. The method for hierarchically optimizing a scheduling plan of a heterogeneous helicopter fleet of claim 2, wherein in step 2, the optimization target function of the mission assignment optimization model and the constraint condition formulas are as follows:
$$Minimize t = max ( {t}_{1} , {t}_{2} , … , {t}_{h} , … ) \qquad ( 27 )$$
$${mc}_{nhk} ∈ {C}_{h} , ∀ n ∈ N , ∀ h ∈ H , ∀ k ∈ {K}_{nh} \qquad ( 28 )$$
$${q}_{n} = {\sum }_{h ∈ H} {\sum }_{k ∈ {K}_{nh}} {mq}_{nhk} , ∀ n ∈ N \qquad ( 29 )$$
$${q}_{r} \geq {\sum }_{n ∈ N} {\sum }_{h ∈ H} {\sum }_{k ∈ {K}_{nh}} ( {mq}_{nhk} \cdot {mr}_{nhkr} ) , ∀ r ∈ R \qquad ( 30 )$$
$${c}_{nh} \geq {mq}_{nhk} , ∀ n ∈ N , ∀ h ∈ H , ∀ k ∈ {K}_{nh} \qquad ( 31 )$$
$${e}_{h}^{M} \geq {mt}_{nhk} + ( {d}_{0 , l 1} + {d}_{l 1 , l 2} + {d}_{l 2 , 0} ) / {v}_{h} \qquad ( 32 )$$
$$l 1 = {mpf}_{nhk} , l 2 = {mpl}_{nhk} , ∀ n ∈ N , ∀ h ∈ H , ∀ k ∈ {K}_{nh}$$
wherein tₕ represents the time spent by a helicopter h to complete all assigned missions, wherein mcₙₕₖ represents the mission type of mₙₕₖ, wherein Cₕ represents a set of mission types capable of being executed by a helicopter h, wherein Kₙₕ represents the number of missions in the mission list that a helicopter h needs to execute to meet a demand n, wherein qₙ represents the quantity of a demand n, wherein mqₙₕₖ represents the mission load of mₙₕₖ, wherein mrₙₕₖᵣ=0/1, and if mₙₕₖ is provided with resources by r, mrₙₕₖᵣ=1, wherein cₙₕ represents the maximum single mission ability of a helicopter h when executing missions with a corresponding demand n, wherein eₕ^{M} represents the maximum duration of flight of a helicopter h, wherein mtₙₕₖ represents the operation time of mₙₕₖ, wherein mpfₙₕₖ represents the first location in the mission route of mₙₕₖ, wherein mplₙₕₖ represents the first location in the mission route of mₙₕₖ.

4. The method for hierarchically optimizing a scheduling plan of a heterogeneous helicopter fleet of claim 3, wherein in step 3, each row of the mission assignment matrix corresponds to one helicopter, and each column of the mission assignment matrix corresponds to one demand, wherein the elements in the mission assignment matrix belong to a mission list, which represent a mission list arranged by the command center for an i^{th} helicopter to satisfy a j^{th} demand, wherein each mission in the mission list possesses four attributes including route, load, type and duration of execution, wherein the mission route of a helicopter may be expressed using a series of numbers, and wherein each number represents a city.

5. The method for hierarchically optimizing a scheduling plan of a heterogeneous helicopter fleet of claim 4, wherein in step 4, the route planning solver uses the adaptive ant-colony algorithm in solving process and uses the branch-and-bound algorithm to verify the best solution.

6. The method for hierarchically optimizing a scheduling plan of a heterogeneous helicopter fleet of claim 5, wherein the adaptive ant-colony algorithm converts the route planning of the helicopter into a problem for optimizing the route search of the ant-colony, wherein Ant represents a category, which possesses attributes including the current city lₕ, the remaining duration of flight eₕ^{l} at the current city, the route currently traveled pₕ, the total distance traveled Dₕ, and the remaining mission list ML_{Ant} wherein the final mission routes of different Ant in Ants may be regarded as an exploration of the best mission route for helicopter h, which is a feasible mission route for the helicopter, wherein during the route exploration of the Ants, the Ant first calculates the mission selection probability pₘ_{ₙₕₖ} of mₙₕₖ in ML_{Ant}, and then selects the next mission based on the roulette principle, wherein in each cycle of the algorithm, all Ant in the Ants are initialized first, and then each Ant searches for a feasible mission route based on the heuristic rule, wherein finally, the Ant having the shortest mission route in that cycle is taken as the best Ant in that cycle of iteration.

7. The method for hierarchically optimizing a scheduling plan of a heterogeneous helicopter fleet of claim 5, wherein in the branch-and-bound algorithm, each node of the search tree is equivalent to an intermediate state of a helicopter during its execution of mission, which possesses four attributes including current node route, time consumption of current route, unfinished mission list and remaining duration of flight, wherein starting from a root node, the branch operation is continuously performed to generate a new generation of nodes until one branch completes all missions and the search tree generates a first end node, wherein subsequently, the search tree performs a pruning operation while stopping the growth of the intermediate node that does not meet the requirement, wherein until all descendant nodes that are newly generated become end nodes, the algorithm is completed.

8. The method for hierarchically optimizing a scheduling plan of a heterogeneous helicopter fleet of claim 5, wherein in step 5, the solver uses a heuristic operator of the pseudo particle swarm algorithm to complete the calculation and optimize the mission assignment matrix, comprising the steps of:
1) generating P_{size} initial mission assignment matrices, wherein each mission assignment matrix corresponds to one particle;
2) evaluating all particles, and solving the best mission routes of all helicopters corresponding to the mission assignment matrix;
3) finding a particle P_{best} with shortest mission completion time from the particles, and moving the particle swarm;
repeating the steps 2) and 3) for Iₘₐₓ times, outputting the best particle in the historical records, and using its corresponding mission assignment matrix as the final solution of the mission assignment solver.
